(19) United States
(12) Patent Application Publication
(10) Pub. No.: US 2025/0261655 A1
(43) Pub. Date: Aug. 21, 2025

(54) Random Strand Vegetable Snack Product

(71) Applicant: Frito-Lay North America, Inc., Plano, TX (US)

(72) Inventors: Kimberly Krenek Hauser, Plano, TX (US); Sanjay Sarang, Plano, TX (US)

(21) Appl. No.: 18/581,109

(22) Filed: Feb. 19, 2024

(51) Int. Cl. A21D 13/047; A21D 2/36; A21D 8/02; A21D 13/045

(52) U.S. Cl. CPC A21D 13/047; A21D 2/362; A21D 2/366; A21D 8/02; A21D 13/045

(57) ABSTRACT

A random strand vegetable snack product includes from about 10% to about 90% of a starch base, from about 10% to about 90% of one or more vegetable substrates and from about 2% to about 5% moisture. The vegetable snack product provides at least 10% of real vegetables and has a bulk density between about 50 g/L to about 84 g/L.

Methods of making a vegetable containing snack product, a dough for forming the vegetable snack product, and a vegetable snack product are described. The vegetable containing snack product contains at least about 10% vegetables, e.g., legumes, pulses, or vegetables.

### BACKGROUND

Increasingly, consumers seek snack products that provide a variety of tastes and textures and may be perceived as “healthy”. To that end, in the field of snack foods there has been a recent focus on producing snack foods that contain vegetable and/or fruit matter. While it is known to make snack foods containing a significant amount of potatoes (e.g., potato chips) or corn (e.g., tortilla chips), there is desire to provide snack products that contain vegetable matter other than potatoes and/or corn. A challenge to producing snack foods that contain vegetable matter other than potato and/or corn is to provide an organoleptically pleasing product while providing a significant amount of vegetable matter. Thus, there is a need to provide a snack food that contains more than an insignificant amount of vegetables, i.e., at least about 10% vegetables, other than potatoes and corn.

It is equally important to provide snack products that have an interesting or attractive appearance with a unique, crispy texture to connote a healthy, natural product. To that end, the inventors have created a random strand vegetable snack products having a nutritionally significant of vegetable material, i.e., at least 10 wt. %.

### SUMMARY

The following disclosure describes a dry mix used to formulate the random strand vegetable containing snack product (may also be referred to as vegetable snack product), a dough formed using the dry mix that is further processed to form the random strand vegetable snack product, the resulting random strand vegetable snack product, and methods of making each.

It has been found that suitable random strand vegetable snack products containing at least 10% vegetables other than potatoes can be made from a dry mix that includes a starch base. The starch base may be formed either from a rice-containing starch base or a potato-containing starch base. The starch base may then be combined with one or more vegetable substrates. In some instances, the vegetable substrate may be free of corn such that the dry mix, dough, and resulting vegetable snack product is free of corn or corn substrates. In other instances, the vegetable substrate may be free of potatoes or potato substrates. It will be appreciated from the foregoing that the vegetable snack product may contain potatoes and corn as part of the starch base and yet, the vegetable substrate may be free of potatoes and/or corn.

The rice-containing starch base (may also be referred to as the rice base) may contain rice, native starch, a gluten-containing substance, and an emulsifier. The rice may be provided as a flour and may be present in the rice base in an amount from about 40% to about 80%. The native starch may be present in the rice base in an amount from about 10% to about 30% and may be provided as a native potato starch, although other native starches may be used. The inventors have discovered that suitable random strand vegetable snack products having a starch base that includes a gluten-containing substance helps retain water and provides cohesiveness and elasticity during the production of the dough used to form the resulting snack product. To that end, the gluten-containing substance may be any suitable gluten-containing substance and may include wheat flour and may be present in the rice base in an amount of at least about 10% and may be present in the rice base in an amount from about 10% to about 30%. The emulsifier may present in the rice base in an amount from about 0.5% to about 3% and one example of a suitable emulsifier may be a soy lecithin.

The potato-containing starch base (may also be referred to as the potato base) may contain potato flakes, native starch, a gluten-containing substance, and an emulsifier. The potato flakes and may be present in the potato base in an amount from about 60% to about 90%. The native starch may be present in the potato base in an amount from about 10% to about 30% and may be provided as a native potato starch, although other native starches may be used. The gluten-containing substance may be wheat flour and may be present in the potato base in an amount from about 5% to about 20%. The emulsifier may be present in the potato base in an amount from about 0.5% to about 3% and one example of such may be a soy lecithin.

Depending on the vegetable substrate, the dry mix may contain between about 10% to about 80% of a total amount of vegetable substrate (as a single vegetable substrate or as two or more vegetable substrates) with the balance being the starch base and optionally, a minor amount of additives. The vegetable substrate may be from any suitable vegetable and, in some instances, is free of decorticated (e.g., dehulled) flours. In some instances, the vegetable substrate is free of potato and/or corn. Generally, the vegetable substrate does not include fresh or individually quick frozen vegetables. Instead, the vegetable substrate may be provided in any suitable dry form such as flour, granules, flakes, clusters, powder or any combination of such dry forms. Suitable vegetable substrates include chickpea, green pea, yellow pea, potato, corn, sweet potato, beets, lentil, lupin, carrot, peppers (green, yellow, red, etc.), beans (e.g., green beans, yellow beans, lima beans, etc.), broccoli, tomato (although it is technically a fruit), celery, spinach, zucchini, cucumber, cauliflower, onion, scallion, asparagus, etc.

The dry mix may also contain optional additives that may include vitamins, minerals, colorants, flavorants, at effective levels of concentration. Such additives may include sucrose, fructose, lactose, dextrose, and honey, polydextrose, dietary fiber, seasonings, such as onion, garlic, parsley, and bouillon, malt, nuts, cocoa, flavorants such as fruit flavoring, acidulants such as citric acid and lactic acid, preservatives such as TBHQ, antioxidants such as tocopherol and BHT, food colorants and the like. It is also contemplated the dry mix, dough, and resulting product may be free of any such additives and as such, it is to be understood that such additives may be excluded from the dry mix, dough, and resulting product.

The dry mix may be preconditioned by hydrating the dry mix with moisture to form a dough containing from about 15% to about 35% moisture. In this regard, each of the dry ingredients may be blended together to form a dry mix which may subsequently be hydrated to form the dough. Alternatively, each of the dry ingredients may be individually added to the water such that all the dry ingredients are present in the mixture so that a dough can be formed.

The dough may be processed in any suitable manner such as, for example, by using a conventional cooking extruder to form a processed dough. Thereafter, the processed dough may be formed into pellets in any suitable manner such as, for example, by using a cold former. The pellets, which may have a soft, pliable cohesive texture are directed to a shredding apparatus (e.g., conventional shredding rolls, which typically include a pair of closely spaced rolls that rotate in opposite directions with at least one of the rolls having circumferential grooves) to form long individual strings or strands that exit the shredding equipment in a random manner onto a moving conveyor and are passed through a compressing apparatus to form a sheet that passes through a cutting apparatus to form individual snack-sized pieces that are then dehydrated and optionally seasoned prior to packaging.

The pieces may then be subjected to any suitable dehydration process such as by drying, baking, toasting, and frying to produce the resulting random strand vegetable snack product (also referred to as the final product) having a moisture content of less than about 5% by weight, or about 0.5% to about 3%, or about 1% to about 2%, based on the total weight of the finished product. The final product may have a shelf stable relative humidity or “water activity” of less than about 0.7, or less than about 0.6, or less than about 0.5. The final product may have a shelf stability of at least about 2 months or at least about 6 months, when stored in proper, sealed packaging.

The random strand vegetable snack products exhibit a visual appearance of a shredded net-like appearance (where each string or strand may have an effective diameter from about 0.1 mm to about 2.0 mm) and possess a crisp shredded texture. Generally, the described snack products are “bite sized” so that they can be easily grasped by a consumer for consumption. As such, the longest dimension of the snack product is between about 10 mm to about 80 mm and has a thickness between about 5 mm and about 20 mm.

The resulting random strand vegetable snack product in an unseasoned state (i.e., does not contain an applied seasoning such as, but not limited to a topical seasoning) may contain from about 10% to about 90% of a base starch, from about 10% to about 90% of a vegetable substrate (where the vegetable substrate may be from a source other than potato or corn), with about 2% to about 5% moisture.

In some aspects the resulting random strand vegetable snack product may contain at least about 10% real vegetables, other than potatoes and corn, which may be present in the starch base. As used in the description and claims, the phrase “real vegetables” refers to vegetables other than corn and refers to vegetables in a dried, powdered, and particulate state such as, for example, flour. With this in mind, the phrase “real vegetables” is intended to exclude whole, cut, diced, raw, cooked, or dried vegetables having a particle size greater than about 500 μm.

It is contemplated that the resulting random strand vegetable snack product may or may not be flavored by applying, topically or otherwise, one or more seasonings to the vegetable snack product in any known manner. When applied, the seasoning or seasonings may comprise from about 1% to about 10%, in the aggregate, of the random strand vegetable snack product.

The random strand vegetable snack product may have a bulk density, in an unseasoned state, between about 50 g/L to about 84 g/L, or about 55 g/L to about 75 g/L.

In one aspect, a dough that can be further processed to form a random strand vegetable snack product includes at least about 10% real vegetables, e.g., legumes, pulses, and/or vegetables other than potatoes and corn, which may be present in the starch base. To that end, as used in this description, reference to vegetables and amounts of vegetables refers to amounts of vegetables other than potatoes and corn that may be present in the starch base. In other words, while the dry mix, dough, and/or resulting random strand vegetable snack product may contain some form of potato or corn, the described dry mix, dough, and vegetable snack product, contain less than 100% of potato and potato-based ingredients and, in some instances, less than about 90% of potato and potato-based ingredients such as potato flour, dried potatoes, potato starch, or other potato or potato-based ingredients. Similarly, while the described dry mix, dough, and vegetable snack product may contain some form of corn, e.g., corn flour, the dry mix, dough, and vegetable snack product contain less than 100% corn and corn-based ingredients and, in some instances less than about 20%, or in some instances less than about 12% of corn and corn-based ingredients such as corn flour.

In addition, reference to the amount of real vegetables provided in the resulting random strand vegetable snack product, is meant to refer to vegetables provided solely with or by the vegetable substrate. In this regard, it will be appreciated that the starch base may contain a potato material, which is not included when calculating the amount of real vegetables present in the resulting random strand vegetable snack product.

According to aspects of the described methods and products, it will be appreciated and it is contemplated that because the described random strand vegetable snack product is formulated to have a bulk density within the range of about between about 50 g/L to about 84 g/L, it will be free of and will not contain pieces or particles of vegetable (or fruit), whether fresh, dehydrated, or present in some other form other than flours or powders. Advantageously, the desired bulk density is achieved in the absence of any leavening agents and, as such, it is contemplated that doughs and the vegetable snack product are free of leavening agents.

Additionally, it is contemplated that the described dry mix, dough, and vegetable snack product may be free of exogenous fibers, proteins, and/or sugars or sweeteners. Exogenous fiber refers to fiber that is added to the dry mix or dough in contrast to fiber that that is naturally present in the ingredients forming the described dry mix, dough, and vegetable snack product, which is considered to be intrinsic (or endogenous) fiber. Examples of exogenous fiber may be inulin and polydextrose, which may be excluded from the described dry mix, dough, and vegetable snack product. Similarly, it is contemplated that the described dough and vegetable snack product may be free of exogenous protein. Exogenous protein refers to protein that is added to the dough in contrast to protein that that is naturally present in ingredients forming the described dough and vegetable snack product (i.e., protein naturally or intrinsically present in, for example, chickpea flour), which is considered to be intrinsic (or endogenous) protein. An example of exogenous protein is albumin. Further, it is contemplated that in some aspects, the described dough and vegetable snack product may be free of exogenous sugar or sweetener. Exogenous sugar or sweetener refer to sugar that is added to the dough (e.g., corn syrup, sugar, cane sugar, etc.) in contrast to sugar that may be naturally present in ingredients forming the described dry mix, dough, and vegetable snack product (i.e., fructose, sucrose and glucose naturally or intrinsically present in, for example, potatoes and potato-based ingredients).

Advantageously, the described snack food products are made by methods that do not require tempering and, in some instances, the methods of making the described snack food products are made using methods in which none of the ingredients are subjected to tempering.

All percentages recited above and in the following description and claims are percent by weight unless specifically noted otherwise. Other aspects and advantages of this invention will be appreciated from the following detailed description.

### BRIEF DESCRIPTION OF THE DRAWINGS

FIG. 1 illustrates one method of preparing a random strand vegetable snack product according to described embodiments.

FIG. 2 is a top plan view of an exemplary random strand vegetable snack product.

### DETAILED DESCRIPTION OF THE INVENTION

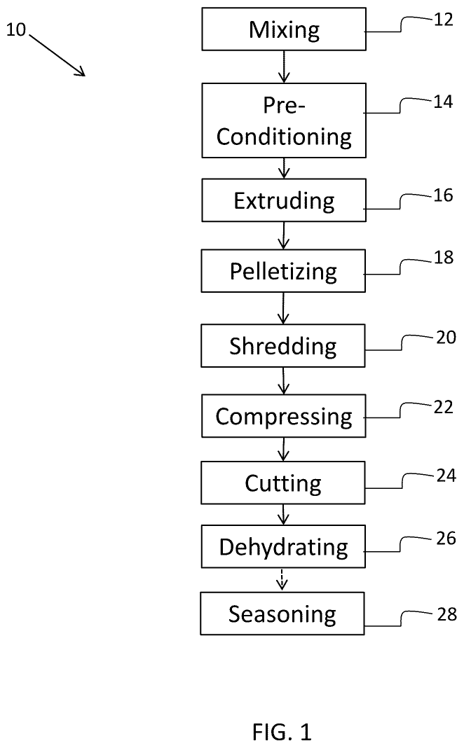

Referring to FIG. 1, an exemplary method 10 for preparing a random strand vegetable snack product is shown. The method 10 includes mixing 12 a plurality of dry ingredients to provide a dry mix. The dry mix can then be pre-conditioned 14 such as by adding water to provide dough having a moisture content between about 15% to about 35%. The dough may then be extruded 16 in a known manner to form an extrudate that may then be directed to a pelletizer 18 to form pellets suitable for shredding using, for example, conventional shredding equipment 20 to form long individual strings or strands that exit the shredding equipment in a random manner onto a moving conveyor and are passed through a compressing apparatus 22 to form a sheet that passes through a cutting apparatus 24 to form individual snack-sized pieces that may then be dehydrated 26 and optionally seasoned 28 prior to packaging (not shown).

As noted above, depending on the vegetable substrate, the dry mix may contain between about 10% to about 90% of a total amount of vegetable substrate (as a single vegetable substrate or as two or more vegetable substrates) with the balance being the starch base and optionally, a minor amount of additives.

### Starch Base

The starch base may be present in the dry mix in an amount from about 10% to about 90%. To that end, the dry mix may include from about 20% to about 85% of a starch base, or about 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, or about 90%. In some aspects, the base starch ingredient may be present in the dry mix in a range where the lower limit may be from any one of about 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, or about 89%, while the upper limit may be from anyone of about 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, or about 90%.

### Rice-Containing Starch Base

As noted above, the starch base may be formed either from a rice-containing starch base or a potato-containing starch base. With respect to the rice-containing starch base, the rice-containing starch base comprises, consists essentially of, or consists of a rice material, native starch, a gluten-containing substance, and an emulsifier. The rice material may be provided in any suitable form but may typically be provided as a flour and may be present in the rice-containing starch base in an amount from about 40% to about 80% or about 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, or about 80%. In some aspects, the rice material may be present in the rice-containing starch base in a range where the lower limit may be from any one of about 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, to about 79%, while the upper limit may be from anyone of about 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, or about 80%.

The native starch may be provided in any suitable form but may typically be provided as a native potato starch (although, as noted above, other native starches may be used) and may be present in the rice-containing starch base in an amount from about 10% to about 30% or about 10%, 11%, 12%, 13%, 14%, 15%, 16%, 17%, 18%, 19%, 20%, 21%, 22%, 23%, 24%, 25%, 26%, 27%, 28%, 29%, or about 30%. In some aspects, the native starch ingredient may be present in the rice-containing starch base in a range where the lower limit may be from any one of about 10%, 11%, 12%, 13%, 14%, 15%, 16%, 17%, 18%, 19%, 20%, 21%, 22%, 23%, 24%, 25%, 26%, 27%, 28%, or about 29%, while the upper limit may be from anyone of about 11%, 12%, 13%, 14%, 15%, 16%, 17%, 18%, 19%, 20%, 21%, 22%, 23%, 24%, 25%, 26%, 27%, 28%, 29%, or about 30%.

The gluten-containing substance may be any suitable gluten-containing substance. Suitable gluten-containing substances include, but are not limited to wheat, barley, rye, spelt, triticale and the like. The gluten-containing substance may be provided as a flour and may be present in the rice base in an amount from about 10% to about 30% or about 10%, 11%, 12%, 13%, 14%, 15%, 16%, 17%, 18%, 19%, 20%, 21%, 22%, 23%, 24%, 25%, 26%, 27%, 28%, 29%, or about 30%. In some aspects, the gluten-containing substance may be present in the rice-containing starch base in a range where the lower limit may be from any one of about 10%, 11%, 12%, 13%, 14%, 15%, 16%, 17%, 18%, 19%, 20%, 21%, 22%, 23%, 24%, 25%, 26%, 27%, 28%, or about 29%, while the upper limit may be from any one of about 11%, 12%, 13%, 14%, 15%, 16%, 17%, 18%, 19%, 20%, 21%, 22%, 23%, 24%, 25%, 26%, 27%, 28%, 29%, or about 30%.

The emulsifier may be any suitable emulsifier such as, but not limited to, lecithin, egg, mono-and diglycerides of fatty acids or derivatives thereof and in some instances, the lecithin may be a soy lecithin. The emulsifier may be present in the rice-containing starch base in an amount from about 0.5% to about 3% or about 0.5%, 0.6%, 0.7%, 0.8%, 0.9%, 1.0%, 1.1%, !.2%, 1.3%, 1.4%, 1.5%, 1.6%, 1.7%, 1.8%, 1.9%, 2.0%, 2.1%, 2.2%, 2.3%, 2.4%, 2.5%, 2.6%, 2.7%, 2.8%, 2.9% or about 3.0%. In some aspects, the emulsifier may be present in the rice-containing starch base in a range where the lower limit may be from any one of about 0.5%, 0.6%, 0.7%, 0.8%, 0.9%, 1.0%, 1.1%, 1.2%, 1.3%, 1.4%, 1.5%, 1.6%, 1.7%, 1.8%, 1.9%, 2.0%, 2.1%, 2.2%, 2.3%, 2.4%, 2.5%, 2.6%, 2.7%, 2.8%, or about 2.9%, while the upper limit may be from any one of about 0.6%, 0.7%, 0.8%, 0.9%, 1.0%, 1.1%, !.2%, 1.3%, 1.4%, 1.5%, 1.6%, 1.7%, 1.8%, 1.9%, 2.0%, 2.1%, 2.2%, 2.3%, 2.4%, 2.5%, 2.6%, 2.7%, 2.8%, 2.9% or about 3.0%.

### Potato-Containing Starch Base

With respect to the potato-containing starch base, the potato-containing starch base comprises, consists essentially of, or consists of potato flakes, native starch, a gluten-containing sources and an emulsifier. The potato flakes may be present in the potato-containing starch base in an amount from about 60% to about 90% or about 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, or about 90%. In some aspects, the potato flakes may be present in the potato-containing starch base in a range where the lower limit may be from any one of about 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, or about 89%, while the upper limit may be from any one of about 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, or about 90%.

The native starch may be provided in any suitable form but may typically be provided as a native potato starch (although, as noted above, other native starches may be used) and may be present in the potato-containing starch base in an amount from about 10% to about 30% or about 10%, 11%, 12%, 13%, 14%, 15%, 16%, 17%, 18%, 19%, 20%, 21%, 22%, 23%, 24%, 25%, 26%, 27%, 28%, 29%, or about 30%. In some aspects, the native starch ingredient may be present in the potato-containing starch base in a range where the lower limit may be from any one of about 10%, 11%, 12%, 13%, 14%, 15%, 16%, 17%, 18%, 19%, 20%, 21%, 22%, 23%, 24%, 25%, 26%, 27%, 28%, or about 29%, while the upper limit may be from anyone of about 11%, 12%, 13%, 14%, 15%, 16%, 17%, 18%, 19%, 20%, 21%, 22%, 23%, 24%, 25%, 26%, 27%, 28%, 29%, or about 30%.

The gluten-containing substance may be any suitable gluten-containing substance. Suitable gluten-containing substances include, but are not limited to wheat, barley, rye, spelt, triticale and the like. The gluten-containing substance may be provided as a flour and may be present in the potato-containing starch base in an amount from about 5% to about 20% or about 5%, 6%, 7%, 8%, 9%, 10%, 11%, 12%, 13%, 14%, 15%, 16%, 17%, 18%, 19%, or about 20%. In some aspects, the gluten-containing substance may be present in the potato-containing starch base in a range where the lower limit may be from any one of about 5%, 6%, 7%, 8%, 9%, 10%, 11%, 12%, 13%, 14%, 15%, 16%, 17%, 18%, or about 19%, while the upper limit may be from any one of about 6%, 7%, 8%, 9%, 11%, 12%, 13%, 14%, 15%, 16%, 17%, 18%, 19%, or about.

The emulsifier may be any suitable emulsifier such as, but not limited to, lecithin, egg, mono-and diglycerides of fatty acids or derivatives thereof and in some instances, the lecithin may be a soy lecithin. The emulsifier may be present in the potato-containing starch base in an amount from about 0.5% to about 3% or about 0.5%, 0.6%, 0.7%, 0.8%, 0.9%, 1.0%, 1.1%, !.2%, 1.3%, 1.4%, 1.5%, 1.6%, 1.7%, 1.8%, 1.9%, 2.0%, 2.1%, 2.2%, 2.3%, 2.4%, 2.5%, 2.6%, 2.7%, 2.8%, 2.9% or about 3.0%. In some aspects, the emulsifier may be present in the potato-containing starch base in a range where the lower limit may be from any one of about 0.5%, 0.6%, 0.7%, 0.8%, 0.9%, 1.0%, 1.1%, 1.2%, 1.3%, 1.4%, 1.5%, 1.6%, 1.7%, 1.8%, 1.9%, 2.0%, 2.1%, 2.2%, 2.3%, 2.4%, 2.5%, 2.6%, 2.7%, 2.8%, or about 2.9%, while the upper limit may be from any one of about 0.6%, 0.7%, 0.8%, 0.9%, 1.0%, 1.1%, !.2%, 1.3%, 1.4%, 1.5%, 1.6%, 1.7%, 1.8%, 1.9%, 2.0%, 2.1%, 2.2%, 2.3%, 2.4%, 2.5%, 2.6%, 2.7%, 2.8%, 2.9% or about 3.0%.

### Vegetable Substrate

As noted above, the vegetable substrate may be provided as particulates such as a flour, powder, or a mixture of a flour and a powder. Generally, the vegetable substrate may be provided as a vegetable flour and, in some instances, is free of decorticated (e.g., dehulled) flours. In this regard, the use of a whole vegetable flour as compared to a decorticated vegetable flour may be more nutritionally desirable since it may contain a higher fiber content, beneficial vitamins and/or bioactive components. In addition, it has been found that the use of pre-cooked (pre-gel) whole vegetable flours does not lead to desirable extruded sheets and thus, leads to undesirable snack products. Accordingly, the described doughs and the vegetable snack product, are free of pre-cooked (pre-gel) whole vegetable flour.

The vegetable substrate may be provided by one or more of legumes, pulses, and vegetables. In some instances, the vegetable substrate is free of potatoes and/or corn. Suitable legumes may include but may not be limited to chickpeas, black beans, green peas, yellow peas, lima beans, kidney beans, black-eyed peas, green beans, yellow beans, and navy beans. Suitable pulses may include but may not be limited to lentils, fava beans, Bambara beans, pigeon peas, lupins, and vetches. Suitable vegetables other than potato and/or corn may include but may be, but are not limited to, sweet potato, carrot, peppers (e.g., green peppers, red peppers, etc.), beets, yams, broccoli, pumpkin, squash, tomato (although it is technically a fruit), celery, spinach, zucchini, cucumber, cauliflower, onion, scallion, asparagus, garlic, etc.

The vegetable substrate may be present in the dry mix in an amount ranging from about 10% to about 90%, or about 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, or about 90%. In some aspects, the vegetable substrate may be present in the dry mix in a range where the lower limit may be from any one of about 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, or about 89%, while the upper limit may be from anyone of about 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, or about 90%.

### Additives

It is contemplated that the dry mix may include additives, i.e., minor quantities of functional ingredients other than those noted above, although it is also contemplated that the dry mix is free of any additives. To that end, when provided, the additives may include vitamins, minerals, colorants, and/or flavorants at effective levels of concentration. Such additives may include sucrose, fructose, lactose, dextrose, and honey, polydextrose, dietary fiber, seasonings, such as onion, garlic, parsley, and bouillon, malt, nuts, cocoa, flavorants such as fruit flavoring, acidulants such as citric acid and lactic acid, preservatives such as TBHQ, antioxidants such as tocopherol and BHT, food colorants and the like. It is also contemplated the dry mix, dough, and resulting product may be free of any such additives and as such, it is to be understood that such additives may be excluded from the dry mix, dough, and resulting product.

Additives, when present, may be included in the dry mix, individually or collectively, in amounts from about 0.01% to about 1%, or from about 0.02, %, 0.03%, 0.04%, 0.05%, 0.06%, 0.07%, 0.08%, 0.09%, 0.1%, 0.2%, 0.3%, 0.4%, 0.5%, 0.6%, 0.7%, 0.8% 0.09%, or about 1%.

In addition, it will be appreciated that the vegetable substrate may impart color to the resulting vegetable snack product. Nevertheless, it is contemplated that additional coloring may be desired. In such instances, it is desired to use natural colorants and to exclude artificial colorants. Natural colorants may include turmeric extract to provide a yellow color or annatto extract to provide a red color. Other natural colorants may be known by the skilled artisan and, as such, are contemplated for inclusion within the dry mix. Depending on the desired color of the vegetable snack product, the vegetable powder may be selected from one or more of tomato, beet (beetroot), spinach, or kale.

When colorants are included in the dry mix, they may be present individually or collectively in amounts from about 0.01% to about 1%, or from about 0.02, %, 0.03%, 0.04%, 0.05%, 0.06%, 0.07%, 0.08%, 0.09%, 0.1%, 0.2%, 0.3%, 0.4%, 0.5%, 0.6%, 0.7%, 0.8% 0.09%, 1%, 1.1%, 1.2%, 1.3%, 1.4%, 1.5%, 1.6%, 1.7%, 1.8%, 1.9%, or about 2.0%.

### Dough

After the dry mix is prepared by mixing the above ingredients, the dry mix may be preconditioned 14 by adding a sufficient amount of moisture at ambient temperature (about 72° F. to about 80° F.) to form a dough. The resulting dough will contain from about 65% to 85% of the above-described dry mix, with the remaining balance being added water or moisture. In some aspects, the dough may contain dry mix in a range where the lower limit may be from any one of about 65%, 66%, 67%, 68%, 69%, 70%, 71%, 72%, 73%, 74%, 75%, 76%, 77%, 78%, 79%, 80%, 81%, 82%, 83%, about 84%, while the upper limit may be from any one of about 66%, 67%, 68%, 69%, 70%, 71%, 72%, 73%, 74%, 75%, 76%, 77%, 78%, 79%, 80%, 81%, 82%, 83%, 84%, or about 85%, or any range that can be created from these values. With these ranges and the above description of the dry mix in mind, the skilled artisan can determine the amount of each of the starch base ingredients, that may be present in the dough.

Regarding the moisture content, the dough will contain from about 15% to about 35%. In some aspects, the dough may contain moisture in a range where the lower limit may be from any one of 15% or about 16%, 17%, 18%, 19%, 20%, 21%, 22%, 23%, 24%, 25%, 26%, 27%, 28%, 29%, 30%, 31%, 32%, 33%, or about 34%, while the upper limit may be from any one of about 16%, 17%, 18%, 19%, 20%, 21%, 22%, 23%, 24%, 25%, 26%, 27%, 28%, 29%, 30%, 31%, 32%, 33%, 34%, or about 35%, or any range that can be created from these values. When the dough contains a moisture content that is outside of the above ranges, it is has been found that an unsuitable random strand vegetable snack results.

Following preconditioning, the dough is subjected to extruding 16 by introducing (in some instances, immediately after formation of the dough) the dough into an extruder to form an extrudate. The extruder may be a single screw or a multi-screw extruder that is capable of delivering a specific mechanical energy of about 30 to about 100 W-h/kg dough. The extruder may be configured with multiple zones such that the temperature at the beginning or entrance of the extruder is between about 220° C. and about 250° C. and the temperature at the end or output of the extruder ranges from about 260° C. to about 300° C. The residence time may range from about 1 second to about 600 seconds.

In some instances, oil may be added during the extrusion process. To this end, the oil may be added intermittently or continuously. Where the extruder has multiple zones, it is contemplated that the oil may be added to one or more or even each zone in an intermittent or continuous manner. The amount of added oil will typically be from about 0.1% to about 3%, or about 0.2%, 0.3%, 0.4%, 0.5%, 0.6%, 0.7%, 0.8%, 0.9%, 1.0%, 1.1%, 1.2%, 1.3%, 1.4%, 1.5%, 1.6%, 1.7%, 1.8%, 1.9%, 2.0%, 2.1%, 2.2%, 2.3%, 2.4%, 2.5%, 2.6%, 2.7%, 2.8%, 2.9%, or about 3.0% The oil may be any oil suitable for oral human consumption.

The extrudate may be directed to a pelletizer 18 to form pellets having a soft, pliable, cohesive texture with a flattened sphere shape. The pellets may have a first size dimension along one axis between about 4 mm to about 7 mm and a second size dimension along another axis between about 3 mm to about 6 mm.

The formed pellets may then be shredded 20 using conventional shredding equipment to form long individual strings or strands that exit the shredding equipment in a random manner onto a moving conveyor. Each string or strand may have an effective diameter of about 0.5 mm to about 1.2 mm. In some instances, each string or strand may have an effective diameter from about 0.1 mm to about 2.0 mm. To this end, each string or strand may have an effective diameter of about 0.1, 0.2, 0.3, 0.4, 0.5, 0.6, 0.7, 0.8, 0.9, 1.0, 1.1, 1.2, 1.3, 1.4, 1.5, 1.6 1.7, 1.8, 1.9, or about 2.0, or within a range that may be created from any of these values. The term “effective diameter” refers to a measure such that the area of a selected length of a non-circular cross section string or strand would be approximately the same as the area of the same selected length of a circular cross section string or strand. One of skill will appreciate that the “effective diameter” is typically applicable in those instances where the string or strand has a non-circular cross section. Further, one of skill will appreciate that, if the string or strand has a circular cross section, the “effective diameter” is equal to the diameter of the string or strand.

After creation of the random-laid strands, they may then be passed through a compressing apparatus 22 to form a sheet that may be passed through a cutting apparatus 24 to form individual snack sized random-strand vegetable snack pieces.

The individual snack pieces may be dehydrated 26 to reduce the moisture content to a suitable level, after which the dehydrated pieces may be seasoned and packaged. The dehydration may be performed using any suitable apparatus such as a drying oven and or frying and the selection of the dehydration apparatus may depend on, for example, the degree of expansion sought. In this regard, it will be appreciated that drying ovens will typically provide a lower degree of expansion while frying will provide a greater degree of expansion, which may provide differing organoleptic experiences. In other words, where a harder, glassy, crunchy product having a lower degree of expansion is sought, the dehydration process may be performed using a drying oven, i.e., impingement oven. On the other hand, where a puffy, crispy, lighter product having a greater degree of expansion is sought, the dehydration process may be performed using a fluidized bed or frying apparatus.

Seasoning 28, if such is performed, may be performed by application of one or more seasonings or flavorings applied to the surfaces of the individual vegetable snack product pieces in a known manner. It will be appreciated that any number of seasoning or flavoring particles or compositions may be applied. By way of example without intending to limit the scope of this disclosure, the additional seasoning or flavoring, may comprise sodium chloride, table salt, kosher salt, sea salt, pepper, paprika, dill, cinnamon, sugar, cardamom, ginger, mustard, parsley, sage, thyme, ranch, barbeque, cheese, vinegar, honey, sour cream, onion, jalapeno, chile, limon, dill pickle, adobadas, and any combination thereof.

In some embodiments, seasoning or flavoring may be added in minor amounts of no more than an average amount of about 10% per individual snack sized piece, depending on the type of flavor profile desired. In this regard, when the seasoning or flavoring is present on the vegetable snack product, it may be present in an amount ranging from about 1% to about 10%, or about 1%, 2%, 3%, 4%, 5%, 6%, 7%, 8%, 9%, or about 10%. In some aspects, the seasoning or flavoring may be present on the vegetable snack product in a range where the lower limit may be from any one of about 1%, 2%, 3%, 4%, 5%, 6%, 7%, 8%, 9%, while the upper limit may be from anyone of about 2%, 3%, 4%, 5%, 6%, 7%, 8%, 9%, 6%, 7%, 8%, 9%, or about 10%.

Thereafter, the vegetable snack product pieces (whether seasoned or not) are packaged into a suitable package. The package may contain only single type of vegetable snack product or may contain more than one type of vegetable snack product.

### Resulting Vegetable Snack Product

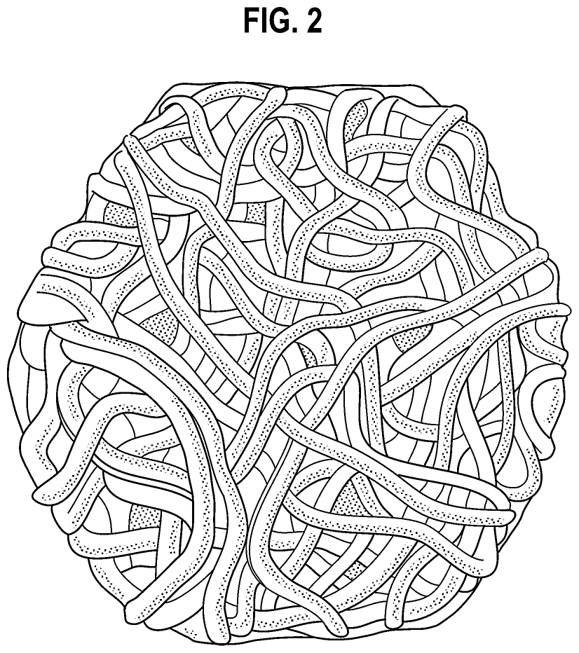

An exemplary resulting random strand vegetable snack product having a hexagonal shape is depicted in FIG. 2. While the exemplary resulting random strand vegetable snack is shown with a hexagonal shape, it should be understood that the resulting random strand vegetable snack product, may be formed into a variety of shapes, which will be dictated by the cutting apparatus.

It will be appreciated that the random strand vegetable snack products exhibit a random shredded or strand net-like appearance. In this regard, it is evident that individual strands are visually perceptible and are randomly oriented with respect to each other in an overlapping manner from the top to the bottom of the individual snack piece. As such, in some instances, visible gaps between individual and collective strands will be present and, it is possible that a visible gap that completely extends from the top to the bottom of the snack. Generally, the described snack products are “bite sized” so that they can be easily grasped by a consumer for consumption. As such, the longest dimension of the snack product is between about 10 mm to about 80 mm and has a thickness between about 1 mm and about 30 mm, or between about 5 mm and about 20 mm.

In some instances, the longest dimension of the snack product may be from about 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, or about 80 mm, or any range that may be created using any of these values. In some instances, the thickness may be about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30 mm, or any range that may be created using any of these values.

The resulting random strand vegetable snack product may comprise, consist essentially of, or consist of about 5% to about 25% of a starch base, from about 10% to about 90% vegetable substrate, from about 2.0% to about 5.0% moisture and optionally from about 0.1% to about 2.0% additives.

Where the resulting random strand vegetable snack product has been produced with a dehydration step that includes frying, the resulting random strand vegetable snack product may comprise, consist essentially of, or consist of about 5% to about 15% of a starch base, from about 10% to about 90% vegetable substrate, optionally from about 0.1% to about 2.0% additives, from about 2.0% to about 5.0% moisture with the remaining being oil, which typically is present in an amount between about 15% and about 35%.

With this in mind, the resulting random strand vegetable snack product may contain from about 5% to about 25% of a starch base, or about 5%, 6%, 7%, 8%, 9%, 10%, 11%, 12%, 13%, 14%, 15%, 16%, 17%, 18%, 19%, 20%, 21%, 22%, 23%, 24%, or about 25%. In some aspects, the starch base may be present in the resulting random strand vegetable snack product in a range where the lower limit may be from any one of about 5%, 6%, 7%, 8%, 9%, 10%, 11%, 12%, 13%, 14%, 15%, 16%, 17%, 18%, 19%, 20%, 21%, 22%, 23%, or about 24%, while the upper limit may be from anyone of about 6%, 7%, 8%, 9%, 10%, 11%, 12%, 13%, 14%, 15%, 16%, 17%, 18%, 19%, 20%, 21%, 22%, 23%, 24%, or about 25%.

The vegetable snack product contains at least about 10% real vegetables provided by one or more vegetable substrates (where the vegetable substrate may be free of potato and/or corn) or from about 10%, 11%, 12%, 13%, 14%, 15%, 16%, 17%, 18%, 19%, 20%, 21%, 22%, 23%, 24%, 25%, 26%, 27%, 28%, 29%, 30%, 131%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, or about 90%.

In some aspects, the vegetable substrate may be present in the vegetable snack product in a range where the lower limit may be from any one of about 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, or about 89%, while the upper limit may be from anyone of about 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, or about 90%.

Additives, when present, may be present in the vegetable snack product, individually or collectively, in amounts from about 0.01% to about 2%, or from about 0.02, %, 0.03%, 0.04%, 0.05%, 0.06%, 0.07%, 0.08%, 0.09%, 0.1%, 0.2%, 0.3%, 0.4%, 0.5%, 0.6%, 0.7%, 0.8% 0.09%, 1%, 1.1%, 1.2%, 1.3%, 1.4%, 1.5%, 1.6%, 1.7%, 1.8%, 1.9%, or about 2.0%.

The random strand vegetable snack product may have a bulk density between about 50 g/L to about 84 g/L, or about 55 g/L to about 75 g/L.

In addition, the random strand snack product can be formed to have two major surfaces, e.g., a top and a bottom and a peripheral surface that connects the top and bottom surface. At least one of the top and bottom and, in some instances, each of the top and bottom of the snack product, includes a plurality of strands with some of the strands being connected to and/or passing over and/or under other strands, as best seen in FIG. 2. While the strands may have any suitable cross sectional shape, they are generally curved or cylindrical. Because some of the strands may pass over and/or under other strands, it will be appreciated that the top and bottom surface have a non-uniform planar appearance. In other words, not all of the strands that are visible from either the top or bottom surface lie in the same plane.

With the above in mind, it will be appreciated that the random strand vegetable snack products exhibit a random shredded or strand net-like appearance. In this regard, it is evident that individual strands are visually perceptible and are randomly oriented with respect to other randomly oriented strands. In addition, visible gaps between individual and collective strands will be present and, it is possible that a visible gap completely extends from the top to the bottom of the snack and vice versa.

In addition, it will also be appreciated that the top surface will have an appearance that differs from the bottom surface due to the random nature of the strands and how the snack product is created (i.e., by laying random strands onto a conveyor). Further, it will be appreciated that because of the nature of the shape of each strand and the random overlaying or underlaying nature of the strands, there may exist gaps in which there are no strands present and which extend from the top surface to the bottom and/or vice versa.

The peripheral surface generally defines a multisided shape, i.e., having three, four, five, six, seven, eight, or nine sides. However, because of the random nature of the strands, each side of the peripheral surface will likely be non-uniform.

Generally, the described snack products are “bite sized” so that they can be easily grasped by a consumer for consumption. As such, the longest dimension of the snack product is between about 10 mm to about 80 mm and has a thickness between about 1 mm and about 30 mm, or between about 5 mm and about 20 mm.

In some instances, the longest dimension of the snack product may be from about 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, or about 80 mm, or any range that may be created using any of these values. In some instances, the thickness may be about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30 mm, or any range that may be created using any of these values.

Where an embodiment is described as comprising some element or group of elements, additional embodiments can consist essentially of or consist of the element or group of elements. Also, although the open-ended term “comprises” is generally used in this description, additional embodiments can be formed by substituting the terms “consisting essentially of” or “consisting of.”

Additionally, when a range for a particular variable is given for an embodiment, an additional embodiment can be created using a subrange or individual values that are contained within the range. Moreover, when a value, values, a range, or ranges for a particular variable are given for one or more embodiments, an additional embodiment can be created by forming a new range whose endpoints are selected from any expressly listed value, any value between expressly listed values, and any value contained in a listed range. For example, if the application were to disclose an embodiment in which a variable is 1 and a second embodiment in which the variable is 3-5, a third embodiment can be created in which the variable is 1.31-4.23. Similarly, a fourth embodiment can be created in which the variable is 1-5.

While the invention has been described in terms of specific or particular embodiments, it should be apparent that alternatives could be adopted by one skilled in the art. In addition, the invention encompasses additional or alternative embodiments in which one or more features or aspects of a particular embodiment could be eliminated or two or more features or aspects of different disclosed embodiments could be combined. Accordingly, it should be understood that the invention is not necessarily limited to any embodiment described herein or illustrated in the drawings. It should also be understood that the purpose of the above detailed description and the phraseology and terminology employed therein is to describe the illustrated embodiments, and not necessarily to serve as limitations to the scope of the invention. Finally, while the appended claims recite certain aspects believed to be associated with the invention, they do not necessarily serve as limitations to the scope of the invention.

1. A vegetable snack product comprising:
from about 10% to about 90% of a starch base;
from about 10% to about 90% of one or more vegetable substrates, other than corn;
from about 2% to about 5% moisture;
wherein the vegetable snack product provides at least 10% of real vegetables and has a bulk density between about 50 g/L to about 84 g/L.

2. The vegetable snack product of claim 1 wherein the starch base includes a rice-containing starch base, wherein a rice material is present in amount that is greater than any other ingredient in the rice-containing starch base, or a potato-containing starch base wherein potato flakes are present in the potato-containing starch base in an amount greater than any other ingredient present in the potato-containing starch base.

3. The vegetable snack product of claim 2 wherein the starch base is a rice-containing starch base that comprises:
a. from about 40% to about 80% of a rice material;
b. from about 10% to about 30% of native starch;
c. at least about 10% of a gluten-containing material;
d. from about 0.5% to about 3% of an emulsifier.

4. The vegetable snack product of claim 3 wherein the gluten-containing material is a wheat flour.

5. The vegetable snack product of claim 2 wherein the starch base is a potato-containing starch base that comprises:
a. from about 60% to about 90% potato flakes;
b. from about 10% to about 30% native starch;
c. at least about 10% of a gluten-containing material;
d. from about 0.5% to about 3% of an emulsifier.

6. The vegetable snack product of claim 1 wherein the one or more vegetable substrates, other than corn is a whole vegetable flour that is free of decorticated and pre-cooked flours.

7. The vegetable snack product of claim 6 wherein the whole vegetable flour is formed from a vegetable selected from chickpea, green pea, yellow pea, potato, sweet potato, beets, lentil, lupin, carrot, green peppers, yellow peppers, red peppers, green beans, yellow beans, lima beans, broccoli, tomato, celery, spinach, zucchini, cucumber, cauliflower, onion, scallion, asparagus, and mixtures thereof.

8. A dough for a random strand vegetable snack product comprising:
a. from 65% to 85% of a dry mix that includes from about 10% to about 90% of a starch base and from about 10% to about 90% of a vegetable substrate; and
b. from 15% to 35% moisture.

9. The dough of claim 8 wherein the starch base includes a rice-containing starch base, wherein a rice material is present in amount that is greater than any other ingredient in the rice-containing starch base, or a potato-containing starch base wherein potato flakes are present in the potato-containing starch base in an amount greater than any other ingredient present in the potato-containing starch base.

10. The dough of claim 9 wherein the starch base is a rice-containing starch base that comprises:
a. from about 40% to about 80% of a rice material;
b. from about 10% to about 30% of native starch;
c. at least about 10% of a gluten-containing material;
d. from about 0.5% to about 3% of an emulsifier.

11. The dough of claim 10 wherein the gluten-containing material is a wheat flour.

12. The dough of claim 9 wherein the starch base is a potato-containing starch base that comprises:
a. from about 60% to about 90% potato flakes;
b. from about 10% to about 30% native starch;
c. at least about 10% of a gluten-containing material;
d. from about 0.5% to about 3% of an emulsifier.

13. The dough of claim 12 wherein the one or more vegetable substrates, other than corn is a whole vegetable flour that is free of decorticated and pre-cooked flours.

14. The vegetable snack product of claim 13 wherein the whole vegetable flour is formed from a vegetable selected from chickpea, green pea, yellow pea, potato, sweet potato, beets, lentil, lupin, carrot, green peppers, yellow peppers, red peppers, green beans, yellow beans, lima beans, broccoli, tomato, celery, spinach, zucchini, cucumber, cauliflower, onion, scallion, asparagus, and mixtures thereof.

15. A method of making a random strand vegetable snack product comprising:
a. providing a dry mix that includes from about 10% to about 90% of a starch base and from about 10% to about 90% of a vegetable substrate;
b. hydrating the dry mix to form a dough containing from 15% to 35% of moisture;
c. introducing the dough to an extruder to form an extrudate;
d. pelletizing the extrudate to form pellets;
e. shredding the pellets using a shredding apparatus to form a plurality of individual strands that exit the shredding apparatus in a random manner;
f. compressing the random individual strands to form a sheet;
g. cutting the sheet into individual snack-size pieces;
h. dehydrating the individual snack-size pieces to form the random strand vegetable snack product having at least 10% of real vegetables and a bulk density between about 50 g/L to about 84 g/L.

16. The method of claim 15 wherein the starch base includes a rice-containing starch base, wherein a rice material is present in amount that is greater than any other ingredient in the rice-containing starch base, or a potato-containing starch base wherein potato flakes are present in the potato-containing starch base in an amount greater than any other ingredient present in the potato-containing starch base.

17. The method of claim 16 wherein the starch base is a rice-containing starch base that comprises:
a. from about 40% to about 80% of a rice material;
b. from about 10% to about 30% of native starch;
c. at least about 10% of a gluten-containing material;
d. from about 0.5% to about 3% of an emulsifier.

18. The method of claim 17 wherein the gluten-containing material is a wheat flour.

19. The method of claim 16 wherein the starch base is a potato-containing starch base that comprises:
a. from about 60% to about 90% potato flakes;
b. from about 10% to about 30% native starch;
c. at least about 10% of a gluten-containing material;
d. from about 0.5% to about 3% of an emulsifier.

20. The method of claim 20 wherein the one or more vegetable substrates, other than corn is a whole vegetable flour that is free of decorticated and pre-cooked flours.

21. The method of claim 20 wherein the whole vegetable flour is formed from a vegetable selected from chickpea, green pea, yellow pea, potato, sweet potato, beets, lentil, lupin, carrot, green peppers, yellow peppers, red peppers, green beans, yellow beans, lima beans, broccoli, tomato, celery, spinach, zucchini, cucumber, cauliflower, onion, scallion, asparagus, and mixtures thereof.

22. A snack product having a top surface, a bottom surface, and a periphery connecting the top and bottom surface wherein at least one of the top surface or the bottom surface has a plurality of strands such that at least one strand is connected to another strand and/or overlays or underlays another strand.
